(19) United States
(12) Patent Application Publication
(10) Pub. No.: US 2005/0073835 A1
(43) Pub. Date: Apr. 7, 2005

(54) Lighting device

(76) Inventor: Reinhold Kett, Vohenstrauss (DE)

Correspondence Address: GRAYBEAL, JACKSON, HALEY LLP, 155 - 108TH AVENUE NE, SUITE 350, BELLEVUE, WA, 98004-5901, US

(21) Appl. No.: 10/713,551

(22) Filed: Nov. 14, 2003

(30) Foreign Application Priority Data
Nov. 14, 2002 (DE) 10253056.4
Nov. 18, 2002 (DE) 10253887.5

(51) Int. Cl. F21V 33/00

(52) U.S. Cl. 362/154

(57) ABSTRACT

A lighting device for an air or gas filled balloon is disclosed. The device includes a cylindrical luminous element having an open end and a closed end, and being adapted to receive an illuminant, which may be an incandescent, chemical or solid state light source, at its open end. The luminous element is sized to fit through a balloon orifice when the orifice is stretched, yet maintain an effective seal therewith when in a non-stretched state. Various embodiments include auxiliary structures to enhance the seal between the balloon and the luminous element, to close the open end of the illuminant, to facilitate routing of electrical wires, to support the illuminant in the luminous element, to enhance support of the balloon relative to the luminous element, to tether the balloon to a fixed structure, and combinations of the above.

The invention relates to a lighting device in accordance with the preamble of claim 1.

A lighting device is known (DE 199 21 798 A1). This known lighting device substantially consists of a balloon inflated with air or gas and of a luminous element including at least one electrically operated light source arranged inside the balloon. The luminous element and the body thereof, respectively, are at the same time designed as a closing element for closing the balloon opening. The light source is provided directly in the interior of the balloon, which is a drawback already because there is no possibility of exchanging the light source without removing the balloon from the body of the luminous element.

Furthermore also sleeve-like seals made of a permanently elastic material for detachable electric plug-in connections are known (DE 42 35 245 C2).

From DE 201 11 117 U1, a lighting device for gas-tight flexible envelopes such as, e.g., balloons is known. This lighting device includes a luminous element accommodated by a luminous element which is received through the opening of the balloon at least partly in the interior of the balloon. A base body which is suited for receiving the luminous element is arranged in the opening of the balloon. After inserting the luminous element, the opening of the base body is closed by a closing element including a seal. Air or gas is supplied to or discharged from the flexible envelope via a separate opening.

DE 100 09 553 A1 shows a sealing head for a balloon inflatable with gas, comprising a tubular outer member for receiving a balloon attached to the sealing head and a gas supply channel for supplying gas through at least one outlet into the attached balloon. Furthermore, a support for a light source for the inside illumination of a balloon attached to the sealing head is provided.

The document 296 21 803 U1 shows a lighting device for an inflatable article such as a ball or the like. This lighting device has a mounting seat member which is integrally connected or bonded to the wall of the gas-tight hollow body during formation of the hollow body. This mounting seat member thus formed integrally with the body to be inflated serves as a base for receiving a luminous element. The luminous element is supported by the mounting seat member and is accommodated inside the hollow body. The hollow body can be inflated, and supplied air or gas can be discharged again via an inflating valve provided separately from the lighting device.

It is the object of the invention to provide a lighting device for lighting balloons inflatable with air or gas, which ensures an effective reliable lighting of the balloon and permits a simple exchange of the illuminant as well as an adjustment of the position of the illuminant in the balloon.

This object is achieved by the features of claim 1. The luminous element has the shape of a cylinder closed on one side, said cylinder being inserted into the interior of the balloon:with its closed end. The cross-section of the surface area of the cylinder is dimensioned such that it is larger than the opening area of the balloon. If the cylinder is inserted into the balloon with its closed end facing the front, a sealing of the balloon at the surface area of the cylinder is provided in a simple way already by dimensioning the cross-section of the cylinder. Since the inserted end of the cylinder is closed, as above-explained, there is no danger of a loss of pressure.

Moreover, the cylinder offers the possibility of accommodating the luminous element in the interior of the cylinder in a simple way, wherein the luminous element can easily be inserted from the open side of the cylinder. Of course, also a simple exchange of the luminous element is possible without the balloon having to be re-inflated. According to claim 1, the open end of the cylinder is closed by a cap having a duct for a connecting cable of the luminous element. This duct is designed so that the cable is displaceable only by applying a particular force. By this second element, numerous functions are fulfilled. On the one hand, the element serves to arrest the luminous element whose position in the balloon can be easily fixed by displacing the cable. Moreover, the element serves as a strain relief for the cable and permits to hang the balloon provided with the lighting device simply on the cable. Furthermore, the element safely seals the cylinder against water or impurities which might penetrate the cylinder from the top when the balloon is mounted so as to be suspended.

Thus, according to the invention, two simple elements are used to provide a reliable, easily mounted lighting device for inflatable balloons, which, moreover, permits to exchange and adjust the luminous element without having to re-inflate the balloon. Furthermore, the luminous element or said cylinder may have different colors so as to achieve most various color effects in a simple manner when lighting balloons.

According to a further development, a simple tension ring is further provided for additionally securing and reliably sealing the balloon at the surface area of the cylinder so as to avoid a loss of pressure in any case when handling the lighting device. Already these two simple elements, namely the cylinder closed on one side and a simple tension ring can ensure a reliable sealing of the balloon without further measures or elements having to be provided for this purpose. Hereinafter, embodiments of the invention shall be explained in detail by way of the figures, in which

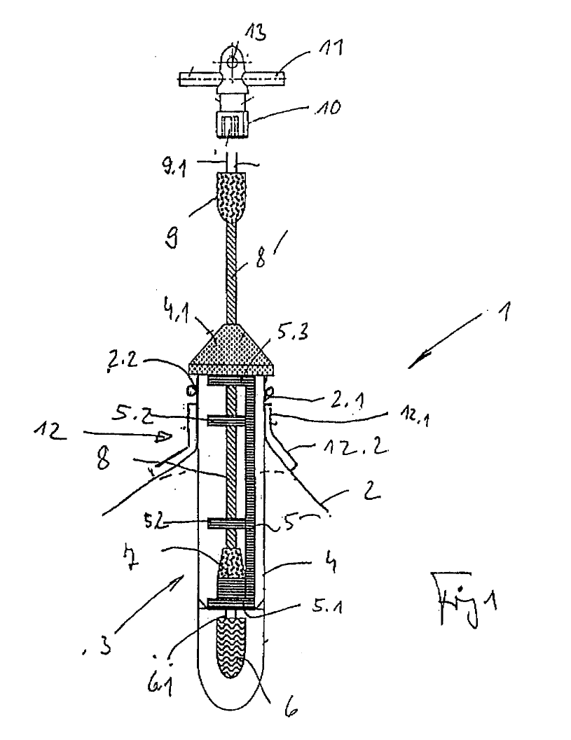

FIG. 1 shows, in a schematic and, partly, a sectional view, a luminous element in a balloon inflated with air or another gaseous medium, together with a joint supply line and a socket provided at the latter; and

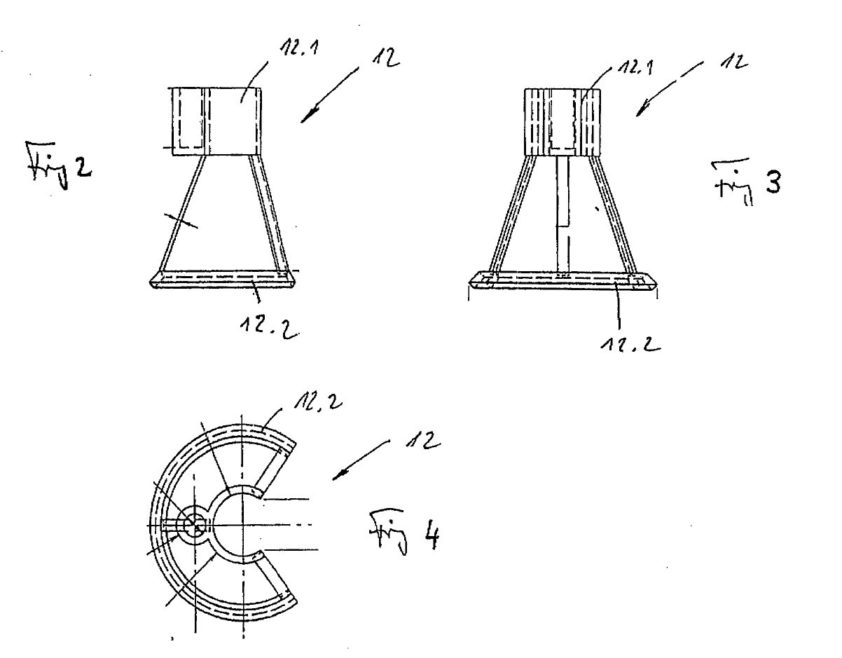

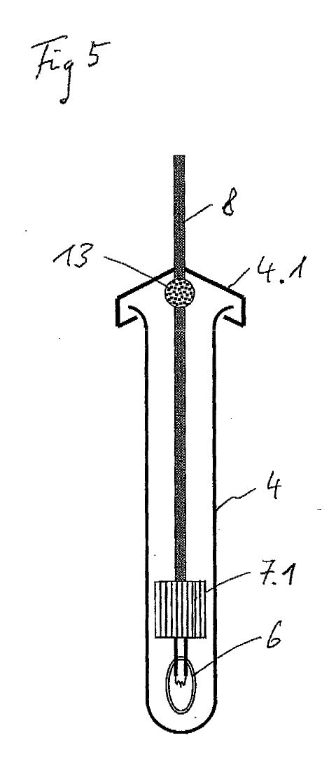

FIGS. 2 to 4 show, in various views, a supporting element for use in the arrangement of FIG. 1,

FIG. 5 shows another embodiment of the invention.

The lighting element generally denoted with 1 in FIG. 1 (for instance effective or party lamp) consists, inter alia, of an inflated, for instance, colored balloon 2, i.e. filled with air and/or gas, and of a luminous element 3 including a lamp or luminous element 4 illuminating said balloon from inside.

The luminous element 4 is made of a translucent material, e.g. a transparent plastic material or glass and, in the represented embodiment, has a shape similar to a test tube, i.e. a cylindrical shape having a rounded bottom. The luminous element 4 is inserted through the opening 2.1 of the balloon 2 into the latter, namely in such a way that the balloon opening 2.1 or rather the nipple including this opening is in a sealing contact with the outer surface of the luminous element 4 so as to seal the interior of the balloon 2. The tight seal in the area of the luminous element 4 is ensured by specific means, for instance by an attached: ring 2.2 (e.g. O-ring). The luminous element 4 is provided with its closed end inside the balloon 2.

The lamp 3 further comprises a support 5 which is inserted from the open side of the luminous element 4 into the same. In the illustration chosen for FIG. 1, the support 5 forms, at its lower end, a plate-shaped section 5.1 which abuts on the inner surface of the luminous element 4 via integrally formed resilient fingers or webs and, in this way, fixes and stabilizes the support 5 in its position at the lower end in the luminous element 4. In the section 5.1, two bore holes are provided through which the pin-shaped connections 6.1 of an illuminant 6 provided below the section 5.1 extend. Above the section 5.1, there is a holder in the form of a socket 7 which receives the connections 6.1 of the illuminant 6 by its socket contacts.

The socket 7 is connected to the one end of an electric line 8 which is guided out of the luminous element 4 to the top and, at its other end, has a plug 9 including two plug contacts 9.1 by which the line 8 can be connected to a socket 10 provided at a joint supply line 11 for plural lamp elements 1.

As is further shown in FIG. 1, the cable 8 extends inside the luminous element 4 along the support 5 and is guided there in respective sections in webs 5.2 of said support as well as at a section 5.3 corresponding to the lower section 5.1. It is designed in such a way that a certain length of the line 8 can be received inside the luminous element 4, namely for instance between the two webs 5.2, so that the length of the line 8 projecting from the luminous element 4 can thereby be increased or reduced. On its upper side, the luminous element 4 is closed by a cap 4.1 through which the line 8 is likewise passed and in which this line is sluggish to displace, i.e. by applying a certain force, namely in such a way that it is not possible to displace the cap 4.1 detachably connected to the luminous element 4 along the line 8 merely due to the dead weight of the lighting element 1 and, thus, a height adjustment of the lighting element 1 fixed to be suspended on the line 8 can be obtained.

In order to hold the balloon 2 in an as centered position as possible to the lamp 3, even if the lamp is arranged so as to be inclined, a supporting element 12 is provided at the outside and is placed onto the luminous element 4 with a section 12.1 such that the balloon 2 is accommodated between the section 12.1 and the luminous element 4. With a conically extending section 12.2, the supporting element 12 forms a contact face for the outer surface of the balloon 2. As is illustrated by FIGS. 2 to 4, the supporting element 12 is designed such that it can be fixed by clipping it on.

FIG. 5 shows a modified embodiment largely corresponding to the embodiment illustrated in FIG. 1. Therefore, only the differences of the embodiments shall be discussed.

In the embodiment according to FIG. 5, a support 5 is dispensed with. Instead, the illuminant 6 is only held by the cable 8 which is connected to the illuminant 6 via a plug-in connection, as in the case of the embodiment according to FIG. 1.

A fixing member 13 is provided in the upper part of the cylinder below the cap 4.1, is clamped to the cable 8 and fixes the position of the illuminant 6 in the cylinder. The fixing member 13 acts as a strain relief and prevents the illuminant 6 from being pulled out of the cylinder when the cable 8 is pulled at. The fixing member 13 permits the lighting device to be suspended on the cable 8 even when it is inserted in the balloon, because—as explained in the foregoing—the fixing member 13 prevents the illuminant 6 from being pulled out of the cylinder. Furthermore, the cap 4,1 is fixedly connected to the cylinder by a snap, so that there is no need to fear that the cap 4.1 is pulled off the cylinder.

Moreover, in this embodiment, a spacer 7.1 is provided in the cylinder, having a diameter smaller than the inside diameter of the cylinder but larger than the outside diameter of the illuminant 6. This spacer 7.1 prevents the illuminant 6 from hitting the inner wall of the cylinder and from being damaged when the lighting device is handled or transported. The spacer 7.1 is adapted to assume the function of the plug-in connection and, at the same time, to establish the electric contact between the cable 8 and the illuminant 6. However, it can also be provided completely independently of a provided plug-in connection exclusively for the purpose of preventing the illuminant 6 from hitting the inner wall of the cylinder. In the device according to the invention, the spacer 7.1 can, of course, be employed independently of the fixing member 13. Likewise, the fixing member 13 can be used independently of the spacer 7.1.

1. A lighting device for balloons inflatable with air or gas comprising an illuminant received by a luminous element which is arranged through the opening of the balloon in the interior of the balloon, characterized in that the luminous element has the shape of a cylinder closed on one side, wherein the closed end is arranged in the interior of the balloon and the surface area of the cylinder is engaged with the opening area of the balloon, wherein the cross-section of the cylinder is dimensioned to be larger than the opening of the balloon and the open end of the cylinder can be closed by a cap through which a cable is guided to the illuminant, the duct being designed so that the cable can be displaced only by applying a certain force.

2. A lighting device according to claim 1, further characterized in that a tension ring is provided on the surface area of the cylinder for additionally securing and sealing the opening of the balloon.

3. A lighting device according to claim 1, further characterized in that the luminous element has a translucent partial area made of glass and/or plastic material.

4. A lighting device according to claim 1, further characterized in that the luminous element as a whole consists of the translucent material.

5. A lighting device according to claim 1, further characterized by a supporting element which is fixed to the illuminant and/or to a partial section of the balloon attached to said illuminant and forming the balloon opening and which forms a supporting face for the outside of the balloon in the area of the balloon opening.

6. A lighting device according to claim 1, further characterized by a support arranged in the luminous element for the at least one illuminant.

7. A lighting device according to claim 6, further characterized in that the support extends in the direction of the longitudinal axis of the luminous element and forms, at one end, a plate-shaped section at which the illuminant or a holder for said illuminant is provided.

8. A lighting device according to claim 1, further characterized in that the cap is part of the holder or support.

9. A lighting device according to claim 1, further characterized in that the illuminant is one of a low voltage lamp, or at least one light diode element.

10. A lighting device according to claim 1, further characterized by a supporting element which can be placed on the luminous element so as to support the balloon.

11. A lighting device according to claim 10, further characterized in that the supporting element has a conically extending supporting section which forms a contact face for the outside surface of the balloon.

12. A lighting device according to claim 10, further characterized in that the supporting element is adapted to be clamped to the luminous element.

13. A lighting device according to claim 1, further characterized in that the cable is provided with a fixing member inside the luminous element.

14. A lighting device according to claim 1, further characterized by a spacer connected to the cable and arranged in the luminous element, said spacer ensuring a predetermined distance between the illuminant and the inner wall of the luminous element.
